(19) United States
(12) Patent Application Publication
(10) Pub. No.: US 2016/0042898 A1
(43) Pub. Date: Feb. 11, 2016

(54) VENTILATED CIRCUIT BREAKERS, VENTILATED CIRCUIT BREAKER HOUSINGS, AND OPERATIONAL METHODS

(71) Applicant: Siemens Industry, Inc., Alpharetta, GA (US)

(72) Inventor: Russell Thomas Watford, Lawrenceville, GA (US)

(21) Appl. No.: 14/456,147

(22) Filed: Aug. 11, 2014

(51) Int. Cl. H01H 37/52; H01H 37/04

(52) U.S. Cl. CPC H01H 37/52; H01H 37/04

(57) ABSTRACT

In one aspect, circuit breakers including ventilation of heat generated by a bi-metal element are disclosed. Circuit breakers include a circuit breaker housing with a heat channel adjacent to a bi-metal element, and a vent exit from the heat channel configured to remove heat generated by the bi-metal element during use. According to another aspect, an electronic circuit breaker including an electronic module with heat ventilation is disclosed. The electronic circuit breaker includes an electronic module including a housing portion forming an electronic circuit chamber that contains electronic circuit components, wherein the housing portion includes one or more vent exits from the electronic circuit chamber configured to remove heat generated by the electronic circuit components during use. Circuit breaker housings and methods of operating circuit breakers are provided, as are other aspects.

### FIELD

The present invention relates generally to circuit breakers, and more particularly to construction of circuit breakers and housings thereof.

### BACKGROUND

In general, a circuit breaker operates to engage and disengage a selected branch electrical circuit from an electrical power supply. The circuit breaker ensures current interruption thereby providing protection to the electrical circuit from continuous over-current conditions and high-current transients due, for example, to electrical short circuits. Such circuit breakers operate by separating a pair of internal electrical contacts contained within a housing of the circuit breaker. Typically, one electrical contact is stationary while the other is movable and may be coupled to a moveable contact arm.

Contact separation between the moving and stationary contacts may occur manually, such as by a person throwing a handle of the circuit breaker. This may engage an operating mechanism that may be coupled to and move the moveable contact arm. Otherwise, the circuit breaker may be automatically tripped when an over-current condition or short-circuit condition is encountered. This automatic tripping may be accomplished by a tripping mechanism that includes a thermal overload element (e.g., a bi-metal element) or by an actuator element (e.g., a magnet), or both. In some embodiments, the actuator may be actuated responsive to an actuation signal sent from on-board electronics (e.g., a printed circuit board) that processes information concerning line current passing through the circuit breaker.

Upon contact separation of the electrical contacts by tripping of the circuit breaker, a substantial electrical arc may be formed. In previous circuit breakers, the arc gases from contact separation have been vented to a side of the circuit breaker housing, such as through conventional arc chute, i.e., a small passage extending from the area adjacent to the contacts to a load side of the circuit breaker.

However, in some circuit breaker designs improved ventilation is desired.

### SUMMARY

According to a first aspect, a circuit breaker is provided. The circuit breaker includes a bi-metal element, and a housing including a heat channel adjacent to the bi-metal element, and a vent exit from the heat channel configured to remove heat generated by the bi-metal element.

In accordance with another aspect, a circuit breaker housing is provided. The circuit breaker housing includes a heat channel adjacent to a bi-metal element, and a vent exit from the heat channel configured and operable to remove heat generated by the bi-metal element.

In accordance with another aspect, a method of operating a circuit breaker is provided. The method includes providing a bi-metal element within a housing of the circuit breaker, providing a heat channel adjacent to the bi-metal element, and venting heat generated by the bi-metal element through a vent exit in the housing.

According to another aspect, an electronic circuit breaker is provided. The electronic circuit breaker includes an electronic module including a housing portion including an electronic circuit chamber containing electronic circuit components, the housing portion including one or more vent exits from the electronic circuit chamber configured to remove heat generated by the electronic circuit components.

According to another aspect, an electronic module housing is provided. The electronic module housing includes a housing portion forming an electronic circuit chamber configured to contain electronic circuit components, and one or more vent exits from the electronic circuit chamber configured to remove heat generated by the electronic circuit components.

In accordance with another aspect, a method of operating an electronic circuit breaker is provided. The method includes providing an electronic module including a housing portion forming an electronic circuit chamber containing electronic circuit components, and venting heat generated in the electronic circuit chamber by the electronic circuit components through one or more vent exits located in the housing portion.

Still other aspects, features, and advantages of the present invention may be readily apparent from the following detailed description by illustrating a number of example embodiments and implementations, including the best mode contemplated for carrying out the present invention. The present invention may also be capable of other and different embodiments, and its several details may be modified in various respects, all without departing from the scope of the present invention. Accordingly, the drawings and descriptions are to be regarded as illustrative in nature, and not as restrictive. The invention is to cover all modifications, equivalents, and alternatives falling within the scope of the invention.

### BRIEF DESCRIPTION OF DRAWINGS

The drawings, described below, are for illustrative purposes only and are not necessarily drawn to scale. The drawings are not intended to limit the scope of the invention in any way.

FIG. 1A illustrates a line-side perspective view of a circuit breaker including improved ventilation according to embodiments.

FIG. 1B illustrates a load-side perspective view of a circuit breaker including improved ventilation according to embodiments.

FIG. 2A illustrates a side plan view of electronic module of a circuit breaker including a portion of a heat channel providing ventilation of a bi-metal element according to embodiments.

FIG. 2B illustrates a side plan view of a portion of the electronic module of a circuit breaker including a portion of a heat channel providing through ventilation according to embodiments.

FIG. 3A illustrates a cross-sectional end view of heat channels and vent exits of a two-pole electronic circuit breaker according to embodiments.

FIG. 3B illustrates a partial top view of a heat channel and vent exit of a circuit breaker including cooling fins in the heat channel according to embodiments.

FIG. 4 illustrates an exploded perspective view of first and second mechanical modules and an electronic module of an electronic circuit breaker (e.g., two-pole circuit breaker) including heat ventilation according to embodiments.

FIGS. 5A and 5B illustrates various exploded perspective views of mechanical module housing portions of a circuit breaker housing including direct bi-metal element ventilation according to embodiments.

FIG. 5C illustrates a cross-sectioned end view of mechanical module of a circuit breaker including direct bi-metal element ventilation according to embodiments.

FIG. 5D illustrates a cross-sectioned side view of a redirector element of a mechanical module including direct bi-metal element ventilation according to embodiments.

FIG. 5E illustrates a top view of a circuit breaker including direct bi-metal element ventilation according to embodiments.

FIGS. 5F-5K illustrates a cross-sectioned side views of alternative redirector elements of a mechanical module according to embodiments.

FIG. 6A illustrates a cross-sectioned side view of an electronic module housing portion of an electronic circuit breaker including ventilation of electronic circuit component contained in an electronic circuit chamber through one or more vent exits according to embodiments.

FIG. 6B illustrates a cross-sectioned end view of an electronic module housing portion of an electronic circuit breaker including ventilation of electronic circuit component contained in an electronic circuit chamber illustrating one of the one or more vent exits according to embodiments.

FIG. 7 illustrates a flowchart of a first method of operating a circuit breaker providing bi-metal heat ventilation according to embodiments.

FIG. 8 illustrates a flowchart of another method of operating an electronic circuit breaker providing heat ventilation of an electronic circuit chamber according to embodiments.

### DESCRIPTION

Reference will now be made in detail to the example embodiments of this disclosure, which are illustrated in the accompanying drawings. Wherever possible, the same reference numbers will be used throughout the drawings to refer to the same or like parts.

During normal operations, mechanical poles of a circuit breaker may generate heat. In an overload condition, such as a persistent overcurrent situation, this heat generation may be increased as compared to normal operational conditions. In some embodiments, such as in electronic circuit breakers, heat generated in the electronic components chamber or compartment of the electronic pole may add to the overall heating effect experienced by the circuit breaker.

Embodiments of the invention are directed at improved ventilation to dissipate heat from a circuit breaker. Ventilation features and one or more vent exits are added to reduce the heat exposure to the circuit breaker components, such as to electronic circuit components of the electronic pole. In some embodiments, one or more heat channels and one or more vent exits may be added to remove heat generated by a bi-metal element. Venting of the bi-metal may be directly, or indirectly. In other embodiments, ventilating features may be added to an electronic module to allow heat generated by electronic circuit components to escape therefrom. These features reduce the heat buildup within the mechanical module(s) and also the electronic module. Heat reduction may be accomplished during ordinary operation, as well during a current overload event in a mechanical module of the circuit breaker. The location of the ventilation features may be provided or contained in variety of modules, such as in one or more of the mechanical module and/or in an electronic module.

In particular, embodiments of the invention may be applied to mechanical modules of circuit breakers, circuit breakers including combinations of at least one mechanical module and an electronic module. Embodiments of the invention may be applied to two-pole residential circuit breakers, such as two-pole circuit breakers rated between about 15 A to 60 A (including 15 A, 20 A, 30 A, 40 A, 60 A). Further, embodiments of the invention may be applied to a single-pole or two-pole thermal/magnetic devices, arc fault circuit interrupters (AFCIs), combination arc fault circuit interrupters (CAFCIs), and/or ground fault circuit interrupters (GFCIs) constructions.

Improved ventilation provided by embodiments of the invention function to allow heat to be effectively removed from the circuit breaker. Advantageously, when used in electronic circuit breakers (such as, for example, AFCIs, CAFCIs, and GFCIs) these features may reduce an amount of heat that is exposed to the electronic module (i.e., the pole including the electronic circuit components).

In one aspect, a circuit breaker including ventilation of a bi-metal element is provided. The circuit breaker includes a housing including with a heat channel adjacent to the bi-metal element, and a vent exit configured to remove heat generated by the bi-metal element from the heat channel. The heat channel may include the bi-metal element in one embodiment, and provided direct ventilation thereof, such as to a top of the housing. In another embodiment, heat channel may be separated from the bi-metal element by a housing side cover portion, and thus may provide indirect ventilation thereof, such as to a top of the housing.

In another embodiment, an electronic circuit breaker is provided including an electronic module (e.g., electronic pole) including a housing portion forming an electronic circuit chamber containing electronic circuit components. The housing portion includes a vent exit from the electronic circuit chamber that is configured to remove heat generated by the electronic circuit components. Thus lower operating temperatures of the electronic circuit components may result.

In view of the foregoing difficulties of heat generation within circuit breakers, both in normal operation and when under non-normal excessive current situations, circuit breakers would benefit from improved ventilation disclosed herein. According to one or more embodiments of the invention, circuit breakers and circuit breaker housings including improved heat ventilation are provided.

It should be recognized that the principles of the present invention are not limited to the illustrative example embodiments depicted herein, but may be applied and utilized in any type of circuit breaker, either mechanical or electronic, such as single-pole circuit breakers, duplex circuit breakers, two-pole circuit breakers, multi-pole circuit breakers, ground fault circuit interrupters (GFCI), arc fault circuit interrupters (AFCI), surge protective devices (TVSS), metering circuit breakers, electronic trip unit breakers, or remotely-controllable circuit breakers.

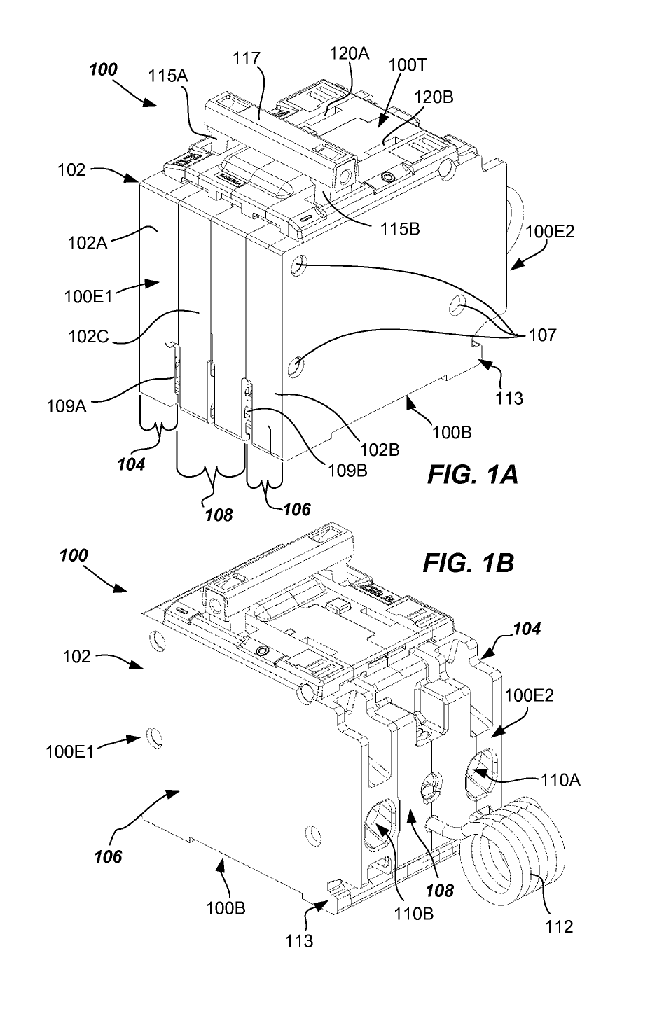

These and other embodiments of circuit breakers and circuit breaker housings including improved thermal control, as well as improved operational methods are described below with reference to FIGS. 1A-8 herein. Like reference numerals used in the drawings identify similar or identical elements throughout the several views.

Referring now to FIGS. 1A through 4, various views of a circuit breaker 100 and components including improved ventilation in accordance with embodiments of the invention are shown. Circuit breaker 100 includes a housing 102, which may be molded case housing made from a suitable plastic material, for example. The material may be a thermoset material, such as a glass-filled polyester, or a thermoplastic material such as a Nylon material (e.g., Nylon 6), for example. Other suitable insulating housing materials may be used.

The circuit breaker 100 and housing 102 may be made up of any number of interconnecting housing pole sections (referred to herein as “modules”). For example, as shown, multiple modules may be connected together to form the circuit breaker 100. In the depicted embodiment, the circuit breaker 100 includes one or more mechanical modules and an electronic module. As shown, a two-pole embodiment of circuit breaker 100 is provided. Circuit breaker 100 includes a first mechanical module 104, second mechanical module 106, and an electronic module 108. The electronic module 108 may be positioned (e.g., sandwiched) between the first mechanical module 104, and the second mechanical module 106. The modules 104, 106, 108 may be fastened together by suitable fasteners 107, such as rivets.

The housing 102 may be made up of, and include, an arrangement of internal and external side covers, which are adapted to contain and/or retain the various components of the circuit breaker 100. In the depicted embodiment, the housing 102 includes a first housing portion 102A configured and adapted to contain the mechanical components of the first mechanical module 104, a second housing portion 102B configured and adapted to contain the mechanical components of the second mechanical module 106, and a third housing portion 102C configured and adapted to contain the electronic circuit components of the electronic module 108 to be described later herein. Each of the first housing portion 102A, second housing portions 102B, and third housing portion 102C made be made up of side wall covers, such as side wall cover halves that interface with each other.

The circuit breaker 100 has a bottom 100B that is configured and adapted to interface with a panelboard or the like, a first end 100E1 configured and adapted to abut an end of other circuit breaker components, as installed, and that may include line terminals 109A, 109B (e.g., c-clips) adapted to contact line conductors on a panelboard or the like, and a second end 100E2 that may include load terminals 110A, 110B. Second end 100E2 may further include a neutral conductor 112 in some embodiments. Second end 100E2 may also include a connection feature, such as racking element 113, which may interface with a flange or other feature on a panelboard. The circuit breaker 100 may include other conventional items, such as handles 115A, 115B on each mechanical module 104, 106 and a handle interconnector 117.

Now referring to FIGS. 1A, 1B, 2A, 2B and 3, the internal some components of a first embodiment of a circuit breaker 100 including bi-metal venting via heat channels is shown. Circuit breaker 100 includes at least one bi-metal element, and may include two bi-metal elements 114A, 114B, in the two-pole version shown. A bi-metal element 114A, 114B may be provided for each pole of the first mechanical module 104 and the second mechanical module 106, respectively. Bi-metal elements 114A, 114B are included within the first mechanical module 104 and the second mechanical module 106. Bi-metal elements 114A, 114B include conventional construction and include two or even more dissimilar materials therein. Each bi-metal element 114A, 114B is provided in the current path of the circuit breaker 100 for each pole (e.g., in a conduction path between a moveable contact of the circuit breaker 100 and a load terminal 110A, 110B thereof), and any persistent over-current condition will cause resistive heating and differential expansion, which causes bending of the affected bi-metal element 114A, 114B and causes the armature 319A, 319B to delatch, causing rotation of the cradle (not shown) and tripping (opening of the internal electrical contacts) of the circuit breaker 100.

The housing 102 may include one or more a heat channels 116A, 116B formed therein, that are formed adjacent to the sides of the bi-metal elements 114A, 114B. Heat channels 116A, 116B may be formed by the interaction of the side covers of the various modules 104, 106, and 108. Thus, as shown, the heat channel 116A may be formed between the first mechanical module 104 and the electronic module 108. The second heat channel 116B may be formed between the second mechanical module 106 and the electronic module 108. Heat channels 116A, 116B include vent exits 120A, 120B. Heat channels 116A, 116B may include fins 321. Fins 321 may extend from near the bottom 100B to near the top 100T in some embodiments to enhance the heat transfer from the second mechanical module side cover 227.

The heat channels 116A, 116B may have a lateral width of between about 2 mm and about 3 mm, and a front-to-back width of between about 10 mm and about 26 mm. Other sizes and configurations of the heat channels 116A, 116B may be used.

In particular, as shown, a first electronic module side cover 215 of the electronic module 108 may include a first portion 218A of the heat channel 116A and a side wall 225 of a first mechanical module side cover 226 of the first mechanical module 104 may close the remaining lateral side of the heat channel 116A. Heat channel 116B is similarly formed. The portion of housing 102 making up the first mechanical module 104 may include the first mechanical module side cover 226 and a second mechanical module side cover 227 which form a cavity 228 into which the bi-metal element 114A is received.

The one or more vent exits 120A, 120B may be located at a top 100T of the circuit breaker 100 and housing 102 and configured to remove heat generated by the bi-metal elements 114A, 114B. In the depicted embodiment, two vent exits 120A, 120B are provided. Vent exits 120A, 120B function to allow heat to escape from the heat channels 116A, 116B out of the top 100T of the circuit breaker 100. Vent exits 120A, 120B may exhaust heat from the top 100T at a location between the handles 115A, 115B and the second end 100E2. In the depicted embodiment, heat flows from the bi-metal element 114A into the side wall 225 and into the heat channel 116A.

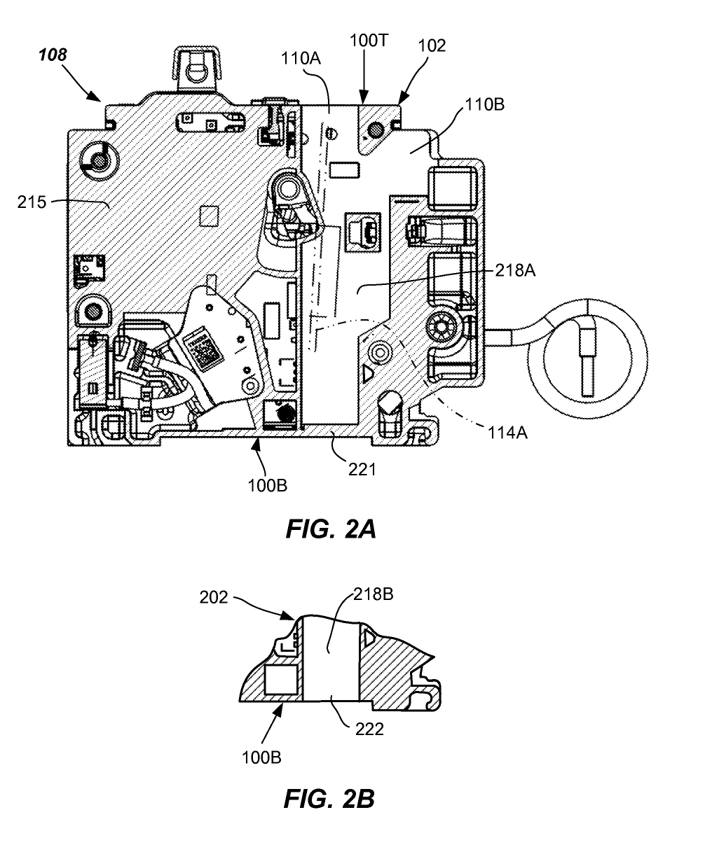

In some embodiments, one or more of the heat channels 116A, 116B extend from the bottom 100B of the circuit breaker 100 and housing 102 to the top 100T of the circuit breaker 100 and housing 102. In some embodiments, a separating wall 221 may remain at the bottom of the heat channels 116A, 116B, while in other embodiments the heat channel portion 218B may include a vent entry 222 at a bottom of the housing 202 as is shown in partial view of FIG. 2B. In the latter embodiment, the heat channels 116A, 116B are open at both the top 100T and bottom 100B.

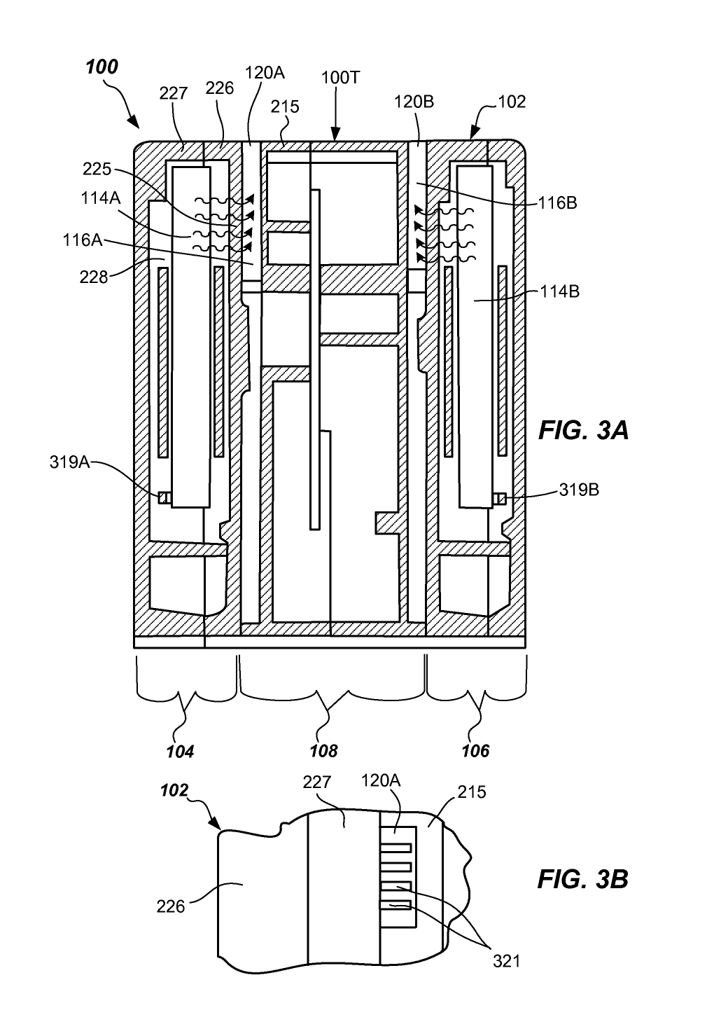

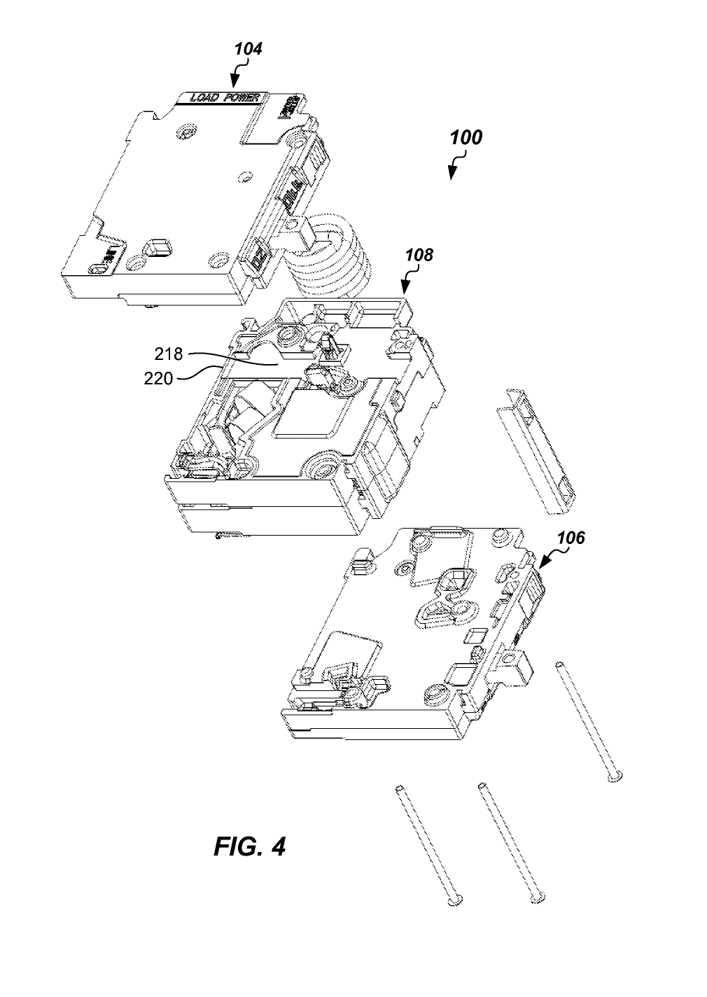

In the depicted embodiment of FIGS. 3A-3B, it should be recognized that the heat channels 116A, 116B are separated from the bi-metal elements 114A, 114B by a side wall 225. The side wall 225 may be part of the first mechanical module side cover 226. FIG. 4 illustrates an exploded perspective view of the circuit breaker 100.

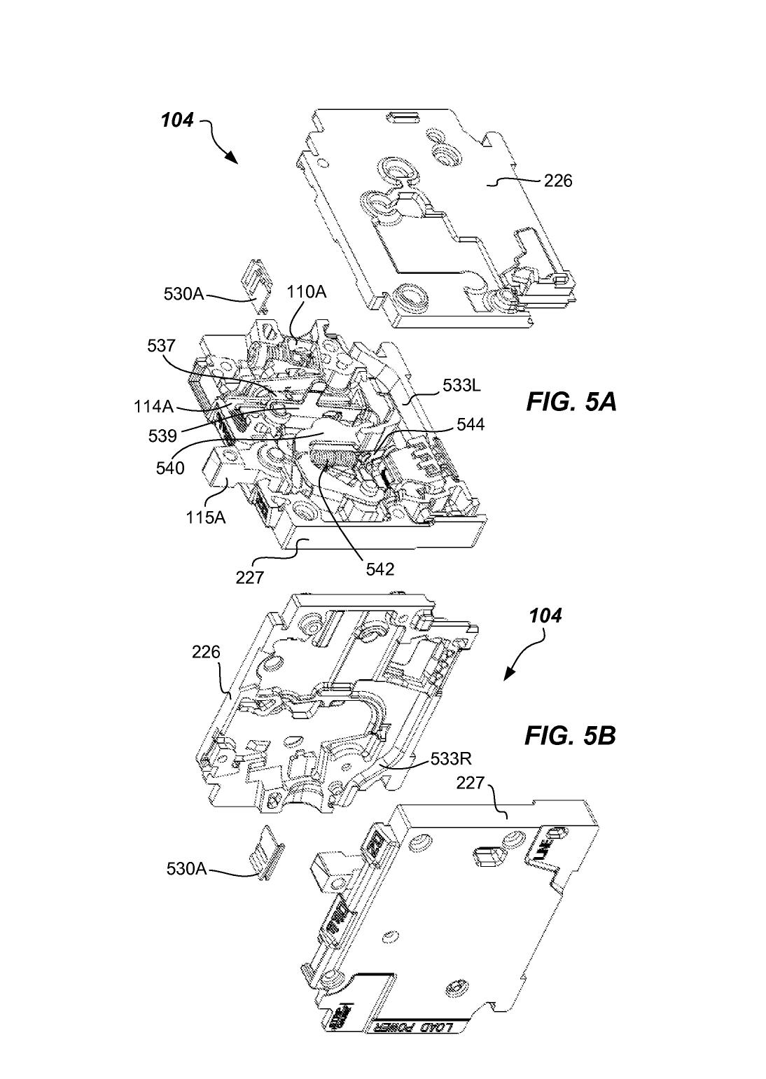

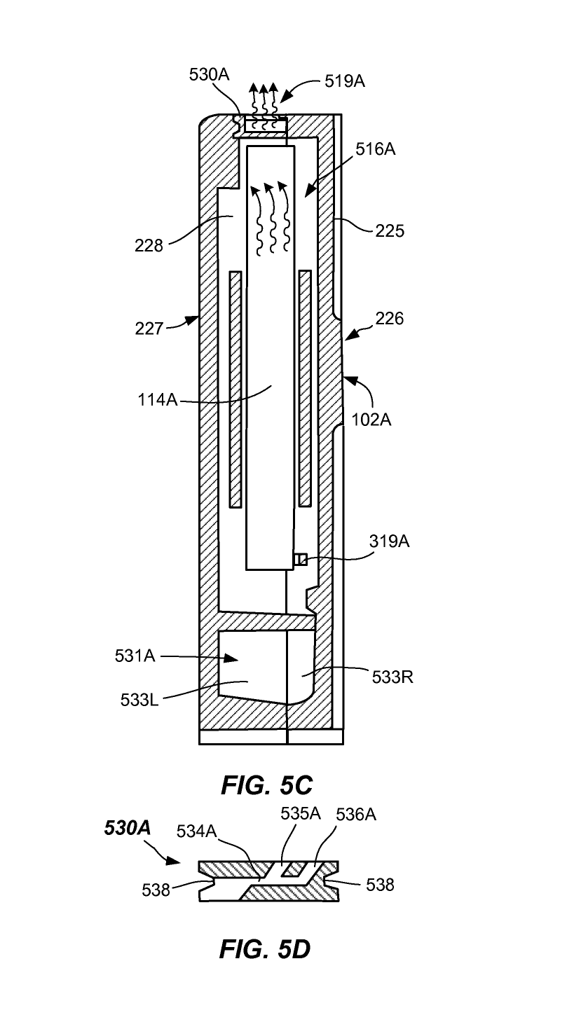

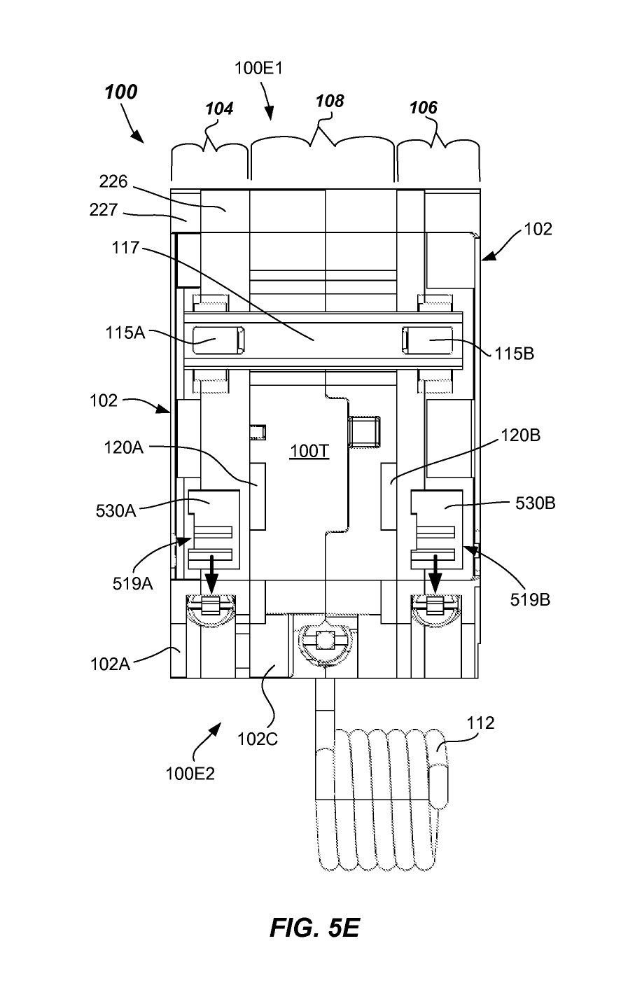

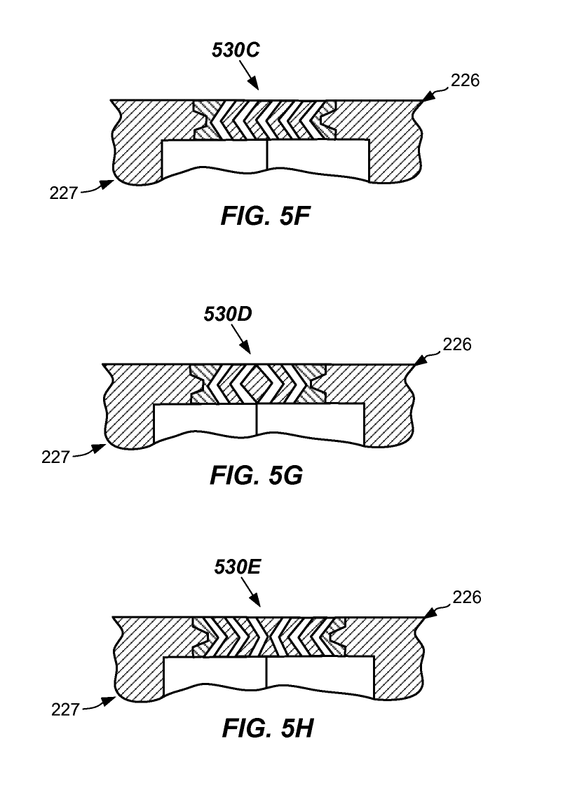

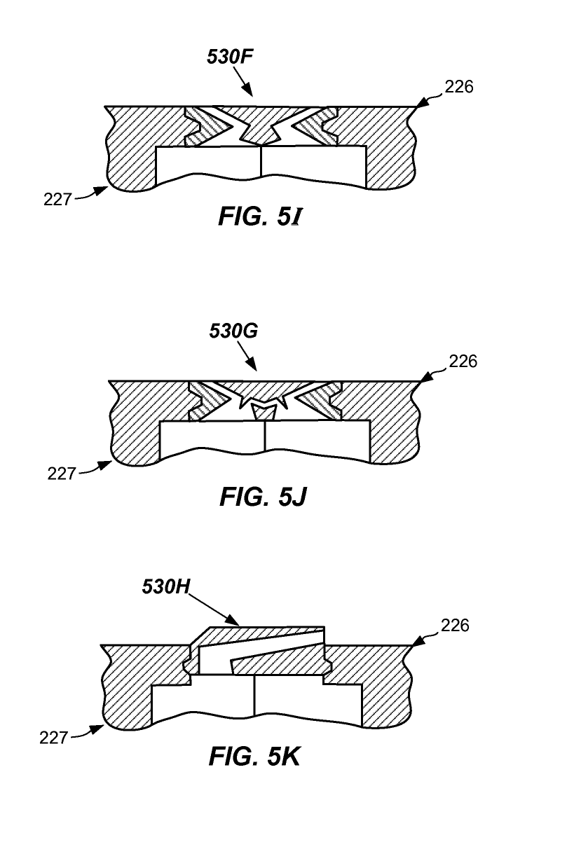

FIGS. 5A-5C illustrate exploded views from different perspectives and a cross-sectional view of an embodiment of the mechanical module 104 that includes direct ventilation of the bi-metal element 114A in accordance with another embodiment. Mechanical module 104 may be used as part of an electronic two-pole circuit breaker 100 as shown in FIG. 5E, for example. However, the principles of embodiments of the invention including direct ventilation of the bi-metal element 114A, as described herein may also be used on an electronic single-pole circuit breaker or even a purely mechanical circuit breaker.

Now referring to FIGS. 5A-5E, the mechanical module 104 includes, as described before, the first mechanical module side cover 226 and the second mechanical module side cover 227. These first and second mechanical module side covers 226, 227 interface with one another to form a cavity 228 that contains the bi-metal element 114A. In the depicted embodiment, the cavity 228 comprises the heat channel 516A, and the heat channel 516A is configured to directly vent heat (represented by arrows in FIG. 5C) from the bi-metal element 114A to and through the vent exit 519A. In the embodiment shown, the heat channel 516A contains the bi-metal element 114A and the bi-metal element 114A is generally surrounded by the heat channel along its length. As shown, the vent exit 519A may be located on a top 100T of the circuit breaker 100 and housing 102. The mechanical module 104 may also include a conventional arc chute 531A formed by arc channels 533L, 533R. Arc chute 531A serves to remove arc gases and debris from the arc chamber (not shown) through an arc exit at the second end 100E2 of the mechanical module.

In some embodiments, the vent exit 519A may comprise a redirector element 530A. Redirector element 530A may include a molded body of a suitable plastic material, as described above, including one or more passages formed therein, such as entry passage 534A, secondary passage 535A, and tertiary passage 536A, as shown in FIG. 5D. Redirector element 530A, as shown, comprises an insert that may be received and captured between the first and second mechanical module side covers 226, 227 of the first housing portion 102A. One or more sides may include retention features, such as grooves 538, to locate and retain the redirector element 530A in the first housing portion 102A. Entry passage 534A may, in operation, receive heat from the heat channel 516A as generated by the bi-metal element 114A, and direct heat flow to secondary and tertiary passages 535A, 536A. One or both of the secondary and tertiary passages 535A, 536A may be configured to redirect air flow away from a handle 115A of the circuit breaker 100.

Each of the secondary and tertiary passages 535A, 536A may include angled surfaces that may angle heat flow away from the handle 115A. The entire passage through the redirector element 530A may be non-straight to let heat escape, but not residue generated by arcing events. Any circuitous route through the redirector element may be provided, such as in the optional configurations of redirector elements 530C through 530H shown in FIGS. 5F through 5K.

Also shown in FIG. 5A are conventional circuit breaker components such as the load terminal 110A, bi-metal element 114A, magnetizible element 537, latch 539, and cradle 540, spring 542, moveable contact arm 544, and handle 115A which are entirely conventional and will not be explained in further detail. The second mechanical module 106 (FIG. 5E) may contain identical components as the first mechanical module 104 and may include direct ventilation through vent exit 519B, which may be through a redirector element 530B. Redirector elements 530A, 530B operate to redirect the heat towards the second end 100E2 and away from the handles 115A, 115B, as shown by arrows.

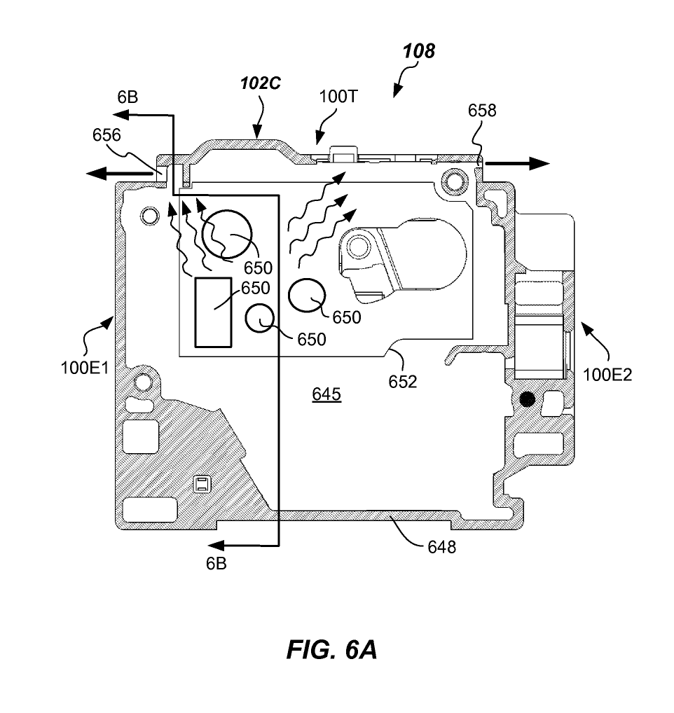

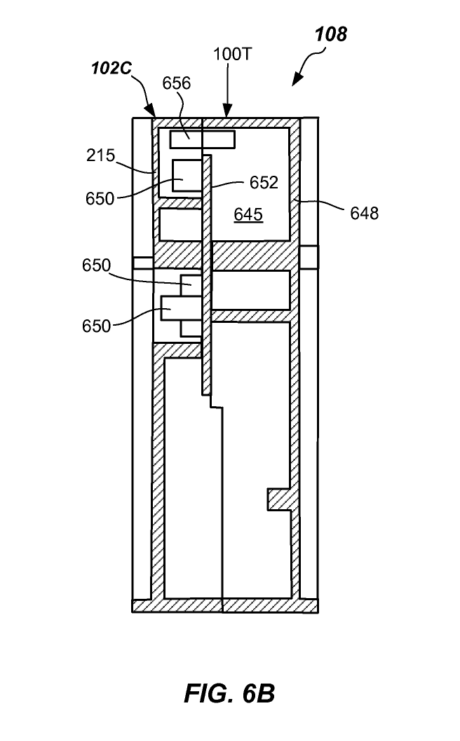

Now referring to FIGS. 6A and 6B, an embodiment of an electronic module 108 for a circuit breaker 100 (e.g., electronic circuit breaker) is shown. Electronic module 108 includes direct ventilation of an electronic circuit chamber 645 containing electronic circuit components. Thus, heat buildup experienced by prior art electronic modules is reduced, which may lead to longer service life.

In more detail, the electronic module 108 includes third housing portion 102C including at least a first electronic module side cover 215 and a second electronic module side cover 648. First electronic module side cover 215 and second electronic module side cover 648 interface to form some or all of the electronic circuit chamber 645. More than just two the side covers may be provided. For example, some embodiments may include a center piece.

Electronic circuit chamber 645 contains electronic circuit components 650 (a few shown), some of which may generate heat during operation. Electronic circuit components 650 may be the application-specific integrated circuit (ASIC), resistors, the power supply, and the like, for example. Some of the electronic circuit components 650 may reside on a printed circuit board 652, for example. The third housing portion 102C of the electronic module 108 may include one or more vent exits from the electronic circuit chamber 645.

In the depicted embodiment, the third housing portion 102C includes a first vent exit 656 and a second vent exit 658. The one or more vent exits (e.g., first and second vent exits 656, 658) are configured to remove heat (designed by wavy arrows) generated by the electronic circuit components 650. In the depicted embodiment, the first vent exit 656 may be located on the first end 100E1 of the third housing portion 102C, and the second vent exit 658 may be located on a second end 100E2 of the third housing portion 102C. The one or more vent exits (e.g., first and second vent exits 656, 658) may be formed in a top 100T of the third housing portion 102C of the housing 102. The first and second vent exits vent exits 656, 658 may be formed by interfacing first and second electronic module side covers 215, 648 of the third housing portion 102C. Each of the first and second vent exits 656, 658 may have, but is not limited to, a cross-sectional area of between about 9 mm² and about 33 mm². Other cross-sectional areas may be used. The first and second vent exits vent exits 656, 658 may have a rectangular cross-sectional shape. However, other shapes may be used. In some embodiments, the first and second vent exits vent exits 656, 658 may be formed part in each of the first electronic module side cover 215 and the second electronic module side cover 648. In others, they may be molded into only one of the first and second electronic module side covers 215, 648. More than one vent exit may be provided on one or both of the first end 100E1 and second end 100E2.

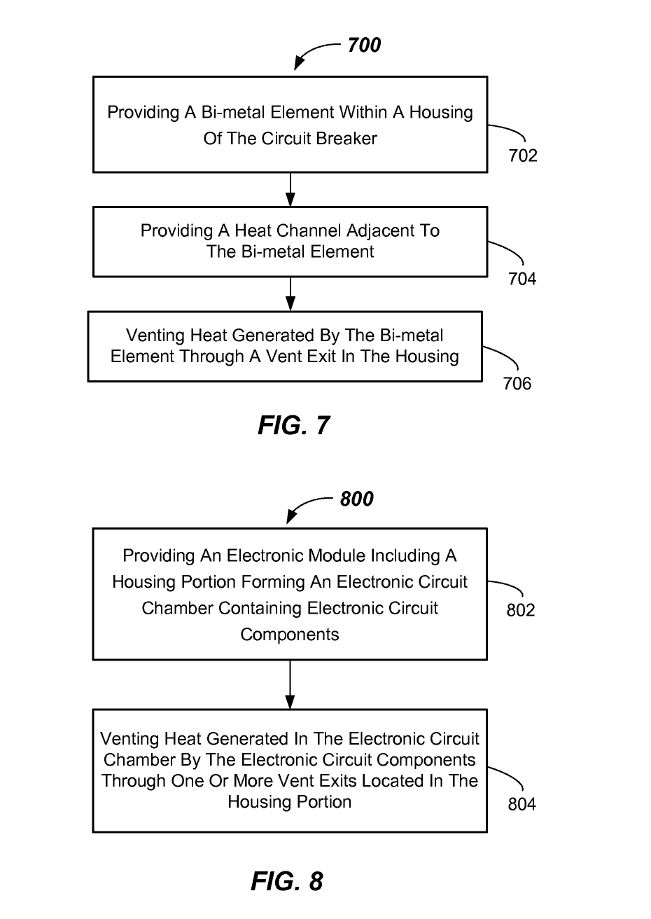

According to another aspect, a method of operating a circuit breaker is provided. As shown in FIG. 7, the method 700 includes, in block 702, providing a bi-metal element (e.g., bi-metal element 114A, 114B) within a housing (e.g., housing 102) of the circuit breaker (e.g., circuit breaker 100).

The method 700 includes, in block 704, providing a heat channel (e.g., heat channel 116A, 116B) adjacent to the bi-metal element, and in block 706, venting heat generated by the bi-metal element through a vent exit (e.g., vent exit 120A, 120B) in the housing.

According to yet another method aspect, a method of operating an electronic circuit breaker (e.g., circuit breaker 100) is provided. As shown in FIG. 8, the method 800 includes, in block 802, providing an electronic module (e.g., electronic module 108) including a housing portion (e.g., third housing portion 102C) forming an electronic circuit chamber (e.g., electronic circuit chamber 645) containing electronic circuit components (e.g., electronic circuit components 650), and, in block 804, venting heat generated in the electronic circuit chamber by the electronic circuit components through one or more vent exits (e.g., first and second vent exits vent exits 656, 658). First and second vent exits 656, 658 may be located on a top (e.g., top 100T) of the housing portion. The electronic module 108 may be coupled to one or more mechanical modules (e.g., first and second mechanical modules 104, 106) and make up a circuit breaker (e.g., circuit breaker 100). However, it should be understood that electronic module 108 may be used only with one mechanical module and be included in a single-pole circuit breaker. Embodiments of the electronic module 108 may be included in other configurations, as well.

While the invention is susceptible to various modifications and alternative forms, specific embodiments and methods thereof have been shown by way of example in the drawings and are described in detail herein. It should be understood, however, that it is not intended to limit the invention to the particular apparatus, systems or methods disclosed, but, to the contrary, the intention is to cover all modifications, equivalents and alternatives falling within the scope of the invention.

What is claimed is:

1. A circuit breaker, comprising:
a bi-metal element; and
a circuit breaker housing including
a heat channel adjacent to the bi-metal element, and
a vent exit from the heat channel configured to remove heat generated by the bi-metal element.

2. The circuit breaker of claim 1, wherein the heat channel extends from a bottom of the circuit breaker housing to a top of the circuit breaker housing, and the vent exit is located at a top of the circuit breaker housing.

3. The circuit breaker of claim 1, wherein the heat channel includes a vent entry at a bottom of the circuit breaker housing.

4. The circuit breaker of claim 1, wherein the heat channel is separated from the bi-metal element by a side cover.

5. The circuit breaker of claim 1, comprising:
a first mechanical module; and
an electronic module, and
wherein the heat channel is formed between the first mechanical module and the electronic module.

6. The circuit breaker of claim 1, comprising:
a first mechanical module;
a second mechanical module; and
an electronic module located between the first mechanical module and the second mechanical module, and
wherein the heat channel is formed between the first mechanical module and an electronic module, and
a second heat channel is formed between the second mechanical module and the electronic module.

7. The circuit breaker of claim 1, wherein the heat channel is configured to directly vent heat from the bi-metal element, wherein the heat channel contains the bi-metal element.

8. The circuit breaker of claim 1, wherein the vent exit comprises a redirector element.

9. The circuit breaker of claim 8, wherein the redirector element includes one or more passages configured to redirect air flow away from a handle of the circuit breaker.

10. The circuit breaker of claim 8, wherein the redirector element comprises an insert received between two cover portions of the circuit breaker housing.

11. A circuit breaker housing, comprising:
a heat channel adjacent to a bi-metal element; and
a vent exit from the heat channel configured and operable to remove heat generated by the bi-metal element.

12. The circuit breaker housing of claim 11, wherein the vent exit is located on a top of the circuit breaker housing.

13. The circuit breaker housing of claim 11, wherein the bi-metal element is contained within the heat channel.

14. The circuit breaker housing of claim 11, wherein the heat channel is separated from the bi-metal element by a housing side cover.

15. A method of operating a circuit breaker, comprising:
providing a bi-metal element within a housing of the circuit breaker;
providing a heat channel adjacent to the bi-metal element; and
venting heat generated by the bi-metal element through a vent exit in the housing.

16. An electronic circuit breaker, comprising:
an electronic module including
a housing portion including an electronic circuit chamber containing electronic circuit components, the housing portion including one or more vent exits from the electronic circuit chamber configured to remove heat generated by the electronic circuit components.

17. The electronic circuit breaker of claim 16, comprising the vent exit located on a first end of the housing portion, and a second vent exit located on a second end of the housing portion.

18. The electronic circuit breaker of claim 16, wherein the vent exit is formed in a top of the housing portion.

19. The electronic circuit breaker of claim 16, wherein the vent exit is formed by interfacing at least first and second electronic module side covers of the housing portion.

20. An electronic module housing, comprising:
a housing portion forming an electronic circuit chamber configured to contain electronic circuit components; and
one or more vent exits from the electronic circuit chamber configured to remove heat generated by the electronic circuit components.

21. A method of operating an electronic circuit breaker, comprising:
providing an electronic module including a housing portion forming an electronic circuit chamber containing electronic circuit components; and
venting heat generated in the electronic circuit chamber by the electronic circuit components through one or more vent exits located in the housing portion.
